(19) United States
(12) Patent Application Publication
(10) Pub. No.: US 2026/0098527 A1
(43) Pub. Date: Apr. 9, 2026

(54) ISOLATION HOUSING FOR ELECTRO-HYDRODYNAMIC AIR MOVER DEVICE

(71) Applicant: Ventiva, Inc., Fremont, CA (US)

(72) Inventors: Jeffrey S. Nespor, Pleasanton, CA (US); Gary Alfred Oliverio, San Jose, CA (US); Himanshu Pokharna, Saratoga, CA (US); Barry O’Connell, Palo Alto, CA (US); Christopher Hizer, Campbell, CA (US); Srikanth Ganesan, Fremont, CA (US); Collin Connors, San Jose, CA (US); Darrick Truong, San Jose, CA (US)

(21) Appl. No.: 19/349,896

(22) Filed: Oct. 3, 2025

Related U.S. Application Data
(60) Provisional application No. 63/704,506, filed on Oct. 7, 2024.
(60) Provisional application No. 63/741,715, filed on Jan. 3, 2025.
(60) Provisional application No. 63/741,706, filed on Jan. 3, 2025.

(51) Int. Cl. F04B 39/12; F04B 37/00; F04B 39/06

(52) U.S. Cl. CPC F04B 39/121; F04B 37/00; F04B 39/06

(57) ABSTRACT

Embodiments of the present disclosure are directed to an isolation housing for an electro-hydrodynamic (EHD) air mover device. The isolation housing includes the EHD air mover device, a shield placed on top of the EHD air mover device forming an upper wall of the isolation housing, a printed circuit board (PCB) assembly forming a bottom wall of the isolation housing, and a chassis made of one or more non-conductive materials and forming side walls of the isolation housing. The PCB assembly carries signal connections for a positive bias voltage signal, a negative bias voltage signal, and/or a ground signal. The chassis is shaped to hold the EHD air mover device in a defined position within the isolation housing. A first surface of the chassis is affixed to the shield, and a second surface of the chassis opposite to the first surface is affixed to the PCB assembly.

### CROSS REFERENCE TO RELATED APPLICATIONS

This application claims a benefit and priority to U.S. Provisional Patent Application Ser. No. 63/704,506, filed on Oct. 7, 2024, and U.S. Provisional Patent Application Ser. No. 63/741,706, filed on Jan. 3, 2025, each of which is hereby incorporated by reference in its entirety.

### BACKGROUND

An electro-hydrodynamic (EHD) air mover device, also known as an ionic fluid mover or ionic air mover, is an electronic device that in a normal operation induces movement of air (or, more generally, fluid—gas or liquid) that surrounds the EHD air mover device, utilizing electromagnetic force to create the air flow without the use of mechanically moving components. This air flow can be referred to as an ionic wind. EHD air mover devices can be installed within larger electronic devices to provide a cooling airflow without the noise or vibration typically caused by mechanical air movers like axial fans. An EHD air mover device typically includes one or more emitter electrodes (or anodes), and one or more collector electrodes (or cathodes), where the emitter and collector electrodes are separated by a physical gap. In the normal operation of the EHD air mover device, a sufficiently large voltage is applied to an emitter electrode, while a collector electrode is maintained at a neutral or ground electrical state and positioned with an air gap separating the emitter from collector electrodes. In this manner, an electrical field gradient is created between emitter and collector electrodes which is strong enough to partially ionize some fluid molecules surrounding the emitter (e.g., air) to create a plasma in the region of the emitter electrode, referred to as a corona discharge.

### SUMMARY

Embodiments of the present disclosure are directed to an isolation housing for an electro-hydrodynamic (EHD) air mover device.

In accordance with one or more embodiments of the present disclosure, the isolation housing includes the EHD air mover device, a shield placed on top of the EHD air mover device, a printed circuit board (PCB) assembly, and a chassis. In some embodiments, the shield forms an upper wall of the isolation housing. In some embodiments, the PCB assembly is made of one or more dielectric materials and forms a bottom wall of the isolation housing. In some embodiments, the PCB assembly includes a PCB that carries signal connections for at least one of a positive bias voltage signal for the EHD air mover device, a negative bias voltage signal for the EHD air mover device, or a ground signal for the EHD air mover device. In some embodiments, the chassis is made of one or more non-conductive materials and forms side walls of the isolation housing. In some embodiments, the chassis is shaped to hold the EHD air mover device in a defined position within the isolation housing. In some embodiments, a first surface of the chassis is affixed to the shield, and a second surface of the chassis opposite to the first surface is affixed to the PCB assembly. In some embodiments, the isolation housing may further include a power supply mounted on top of the PCB assembly. In some embodiments, the power supply generates at least one of the positive bias voltage signal or the negative bias voltage signal for the EHD air mover device.

Embodiments of the present disclosure are further directed to a housing assembly that includes a plurality of isolation housings for a plurality of EHD air mover devices. In some embodiments, each isolation housing in the housing assembly includes a respective EHD air mover device, a shield placed on top of the respective EHD air mover device, and a chassis made of one or more non-conductive materials that is affixed to the shield and shaped to hold the respective EHD air mover device in a defined position. In some embodiments, the housing assembly further includes a PCB assembly made of one or more dielectric materials that forms a bottom wall of the housing assembly. In some embodiments, the chassis of each isolation housing is affixed to the PCB assembly. In some embodiments, the PCB assembly includes a PCB that carries signal connections for at least one of a positive bias voltage signal for each EHD air mover device, a negative bias voltage signal for each EHD air mover devices, or a ground signal for each EHD air mover device.

### BRIEF DESCRIPTION OF THE DRAWINGS

FIG. 1 illustrates a process of fluid movement in an electro-hydrodynamic (EHD) fluid mover device, in accordance with one or more embodiments.

FIG. 2A illustrates a front view of an EHD air mover device, in accordance with one or more embodiments.

FIG. 2B illustrates a bottom view of an EHD air mover device, in accordance with one or more embodiments.

FIG. 2C illustrates a detailed view of components of an EHD air mover device, in accordance with one or more embodiments.

FIG. 2D illustrates an emitter terminal, which is an alternative implementation of conductive metal terminal, in accordance with one or more embodiments.

FIG. 3A illustrates components of an isolation housing for an EHD air mover device (i.e., “EHD housing”), in accordance with one or more embodiments.

FIG. 3B illustrates a top view of an EHD housing placed on a bottom of housing of an electronic device into which the EHD air mover device is integrated, in accordance with one or more embodiments.

FIG. 4A illustrates a side angled view of an EHD housing, in accordance with one or more embodiments.

FIG. 4B illustrates an enlarged side view of an electrical contact between a positive high-voltage metal terminal of an EHD air mover device and a pogo pin that affixes an EHD chassis to a printed circuit board (PCB) assembly of an EHD housing, in accordance with one or more embodiments.

FIG. 4C illustrates a cross-sectional side view of an electrical contact between a Collector Electrode metal tab (207) of an EHD air mover device and another pogo pin that affixes the EHD chassis to the PCB assembly of the EHD housing, in accordance with one or more embodiments.

FIG. 4D illustrates a cross-sectional side angled view of the EHD housing, in accordance with one or more embodiments.

FIG. 5 illustrates a cross-sectional view of an EHD housing, in accordance with one or more embodiments.

FIG. 6 illustrates a cross-sectional view of an outside isolation for an EHD housing, in accordance with one or more embodiments.

FIG. 7 illustrates a top view of an EHD assembly including an elongated PCB assembly and multiple EHD housing modules, in accordance with one or more embodiments.

FIG. 8 illustrates a top view of an EHD assembly including a PCB assembly, two EHD housing modules and an EHD power supply, in accordance with one or more embodiments.

FIG. 9 illustrates a top view of an EHD assembly including a PCB assembly with three EHD housing modules and an EHD power supply, in accordance with one or more embodiments.

FIG. 10 is a flowchart for a method of assembling an EHD housing, in accordance with one or more embodiments, in accordance with one or more embodiments.

### DETAILED DESCRIPTION

### Introduction

A state of an impeded EHD air mover device operation may occur when the desired ionic flow ceases, which occurs when the normal positive ion flow from the emitter electrode to the collector electrode is dominated by a sudden electron flow (i.e., electrical current) between the emitter electrode and the collector electrode, known as an arc, spark, or short circuit. During such an arc event, the relative voltage differential between the emitter electrode and the collector electrode collapses due to the low impedance of an arc, which in turn would stop the corona discharge, and thus no ionic pressure head or flow is created by the device during such arcing state. Therefore, to allow for the stable control of the electrical field and mitigate the risk of arcing within the EHD air mover device, a minimum gap or distance between any portion of an emitter electrode and the nearest collector electrode needs to be maintained at a precise distance.

However, there is a technical problem of achieving a small form factor of an EHD air mover device (e.g., for installing the EHD air mover device in smaller electronic devices, such as tablet or laptop computers) while maintaining a necessary gap between an emitter electrode and a collector electrode required to avoid arcing. Additionally, the EHD air mover device needs to be secured in order to isolate components of an electronic device being cooled by the EHD air mover device from an electrical field of the EHD air mover device.

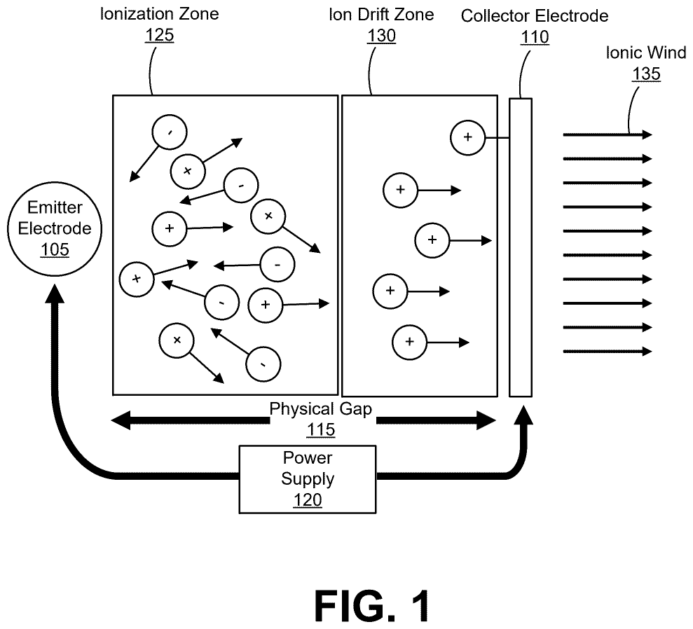

FIG. 1 illustrates a process of fluid movement (e.g., air movement) in an electro-hydrodynamic (EHD) fluid mover device 100, in accordance with one or more embodiments. The process of fluid movement in the EHD fluid mover device 100 can be achieved without any moving parts of the EHD fluid mover device 100. The EHD fluid mover device 100, also known as an ionic fluid mover or ionic air mover, is an electronic device that in a normal operation induces movement of fluid molecules that surround the EHD fluid mover device 100, typically air but may also be other gases or liquids, utilizing electromagnetic force to create such flow without the use of mechanically moving components. This flow can be referred to as an ionic wind.

As shown in FIG. 1, the EHD fluid mover device 100 may include an emitter electrode 105 (or anode) and a collector electrode 110 (or cathode) separated by a physical gap 115, e.g., an air gap. The EHD fluid mover device 100 may further include a power supply 120 that provides an electrical power required for operation of the EHD fluid mover device 100. By applying a large differential voltage between the emitter electrode 105 and the collector electrode 110, an electrical field may be created between the emitter electrode 105 and the collector electrode 110. In one or more embodiments, a positive biased voltage of the power supply 120 is applied to the emitter electrode 105 (e.g., in the order of 2,500V to 8,000V), while the collector electrode 110 remains neutral or grounded. Alternatively, a negative biased voltage of the power supply 120 may be applied to the collector electrode 110.

The electrical field created in the physical gap 115 may need to be established and maintained at a sufficiently large magnitude to create an electrical field gradient between the emitter electrode 105 and the collector electrode 110 that is strong enough to partially ionize surrounding fluid molecules (e.g., air molecules) and create a plasma in a region in a vicinity of the emitter electrode 105, which is referred to as a corona discharge. The region having the partially ionized fluid molecules that create the corona discharge is illustrated in FIG. 1 as an ionization zone 125. It should be noted that the electrical field created in the physical gap 115 should be set not to be too large to exceed a dielectric resistance of the physical gap 115. Exceeding the dielectric resistance of the physical gap 115 by the electrical field would cause a sudden electrical current (e.g., arc or spark) between the emitter electrode 105 and the collector electrode 110 due to a short circuit established by the electrical breakdown of air or fluid across the physical gap 115. Alternatively or additionally, exceeding the dielectric resistance of the physical gap 115 by the electrical field may cause a flow of electrical current along a surface of any non-conductive structure that is between the emitter electrode 105 and the collector electrode 110. This flow of electrical current can be referred to as an electrical creep, while a shortest path distance between any conductors of the EHD fluid mover device 100 can be referred to as a creep path distance.

Ionized molecules (e.g., positively ionized molecules) created in the area of corona discharge (i.e., in the ionization zone 125) may be accelerated toward the collector electrode 110 via an electromagnetic force exerted by the electrical field. Hence, an ion drift zone 130 with the ionized molecules may be created in a vicinity of the collector electrode 110. Enroute to the collector electrode 110 and in the ion drift zone 130 the ionized molecules may collide with surrounding neutral fluid molecules and impart momentum on the neutral molecules, thus creating the net fluid movement which is detected as a pressure head and flow similar to that produced by a mechanical fan, which can be referred to as an ionic wind 135. The generated ions eventually pass their charge to nearby areas of lower potential or recombine to form neutral gas molecules again.

The corona discharge may be positive or negative, determined by the polarity of the voltage applied to each electrode of the EHD fluid mover device 100, which have different underlying properties associated with their respective predominant electrical bias (i.e., positive, or negative). In one or more embodiments, the EHD fluid mover device 100 in a normal operation utilizes a large positive voltage applied to the emitter electrode 105 (e.g., shaped as a wire), while the collector electrode 110 is neutral or ground, and thus creates a positive corona discharge. The positive corona discharge is strongly favored for normal operations of small-factor EHD fluid mover devices intended for use within confined volumes, such as internal to an electronic consumer device to create a cooling airflow. This is because, as compared to negative corona discharge, the positive corona discharge can be created in preferred small geometries and has other advantages such as a lower creation rate of ozone molecules when operating in the air.

The corona discharge can form at locations near the high voltage emitter electrode 105 where the electrical field potential gradient is the highest—at sharp points or at regions of small radii on the emitter electrode 105, such as sharp corners or edges, projecting points, or small diameter wires where the high curvature causes a high potential gradient at these locations. In one or more embodiments, the EHD fluid mover device 100 utilizes a small radius wire-type emitter electrode 105, so as to establish a corona discharge along the length of the wire electrode and thus induce ionic flow along the entire length dimension of the EHD fluid mover device 100 where the emitter electrode 105 is exposed to a surrounding fluid (e.g., air).

A state of an impeded operation of the EHD fluid mover device 100 may occur when the desired ionic flow within the physical gap 115 ceases, i.e., when the normal positive ion flow from the emitter electrode 105 to the collector electrode 110 is dominated by a sudden electron flow (i.e., electrical current) between the collector electrode 110 and the emitter electrode 105, which is known as an arc, spark, or short circuit. During such an arc event, the relative voltage differential between the emitter electrode 105 and the collector electrode 110 collapses due to the low impedance of an arc, which in turn would stop the coronal discharge, and thus no ionic pressure head or flow is created by the EHD fluid mover device 100 during such arcing state.

In the normal operation of the EHD fluid mover device 100, the electrical field must be maintained at a level strong enough to ionize molecules of the fluid near the emitter electrode 105 (i.e., to form the ionization zone 125), but below a natural dielectric breakdown voltage of the fluid in the physical gap 115 (e.g., approximately 3 kV/mm for air, or some other limit as determined by the dielectric breakdown of an alternate surrounding fluid), so as not to cause a current discharge or arc between the emitter electrode 105 and the collector electrodes 110 across the physical gap 115. Additionally, a minimum gap or distance between any portion of the emitter electrode 105 and a nearest portion of the collector electrode 110 needs to be maintained at a precise distance to allow for the stable control of the electrical field thus mitigating the risk of arcing.

Accordingly, specific factors need to be considered when designing the EHD fluid mover device 100, including but not limited to: (i) the precise mechanical positioning and physical stability of the emitter electrode 105 and the collector electrode 110 in relation to each other to maintain the desired distance between the emitter electrode 105 and the collector electrode 110, and thus enable predictable operation of the EHD fluid mover device 100 without any arcing; and (ii) the measurement and control of the power being supplied to the emitter electrode 105 to optimize a strength of the electrical field between the emitter electrode 105 and the collector electrode 110, as well as to mitigate and/or respond to changing conditions which can result in a changed likelihood of arcing.

As aforementioned, the operation of the EHD fluid mover device 100 requires establishing an electrical field gradient between the emitter electrode 105 and the collector electrode 110, which can be achieved by applying a large differential voltage between the emitter electrode 105 and the collector electrode 110. For example, during the normal operation of the EHD fluid mover device 100, the emitter electrode 105 can typically have a voltage applied in the order of 2,500V to 8,000V, while the collector electrode 110 remains neutral or grounded. Due to the strong electrical field between the emitter electrode 105 and the collector electrode 110, the normal operation of the EHD fluid mover device 100 may require an isolation between the emitter electrode 105 and the collector electrode 110 to minimize or at least reduce inadvertent short circuits caused by the flow of electrical charge along the shortest path along the outer surface of an otherwise generally non-conductive material between two locations of high differential electrical potential (i.e., electrical creep). Containing the electrical field within a non-conductive housing, and/or robust grounding or shielding of all external conductive components near the EHD fluid mover device 100 may be required to eliminate the possibility of imparting a harmful electrical charge onto external device components near the EHD fluid mover device 100, which can lead to damaging short circuits or arcs between the high-voltage elements of the EHD fluid mover device 100 (e.g., the high-power boost stage of the power supply 120, or the emitter electrode 105 when operating under high voltage) and conductive external components within an electronic device in which the EHD fluid mover device 100 is installed.

To minimize or at least reduce a total power consumed by the EHD fluid mover device 100, so as to enable the EHD fluid mover device 100 to operate within a battery-powered electronic device without adversely affecting overall battery life as compared to a typical axial fan, the EHD fluid mover device 100 should consume no more than between 1 W and 3 W of the total power during the normal operation. At the required voltage and power levels for the normal operation of the EHD fluid mover device 100, the power supply 120 may need to be able to provide the voltage to the emitter electrode 105 in the order of 2,500V to 8,000V, and at an electrical current in the order of 10 uA to 600 uA. To operate the EHD fluid mover device 100 in a typical consumer electronic device, an input power rail to the EHD fluid mover device 100 should be between 5V and 24V. Therefore, the power supply 120 needs to be able to accept a low voltage input in the order of 5V to 24V, output a high voltage very low current power, in the order of 2,500V to 8,000V at 10 uA to 600 uA, for a total power that is less than 3 W. Additionally, the power supply 120 may require to be dynamically controlled for adapting to detected rates of arcing caused by changes in the dielectric breakdown level of the air or other surrounding fluid in the physical gap 115, changes in a distance between the emitter electrode 105 and the collector electrode 110, contaminants on the emitter electrode 105 and the collector electrode 110 that may cause localized concentration of the electrical field, some other conditions that can lead to arcing, or some combination thereof.

### Electro-Hydrodynamic Air Mover Device

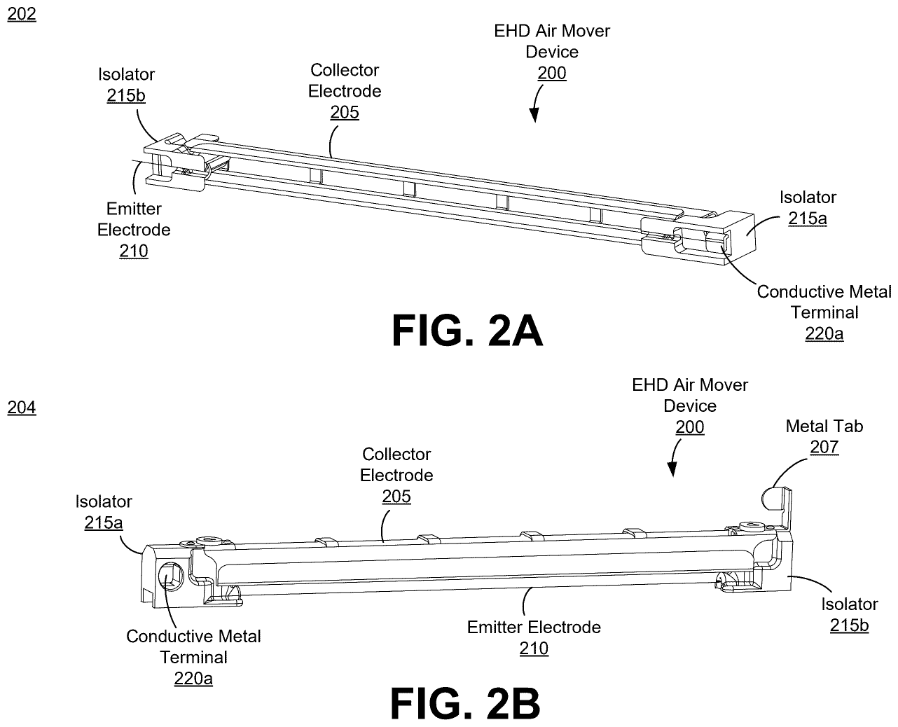

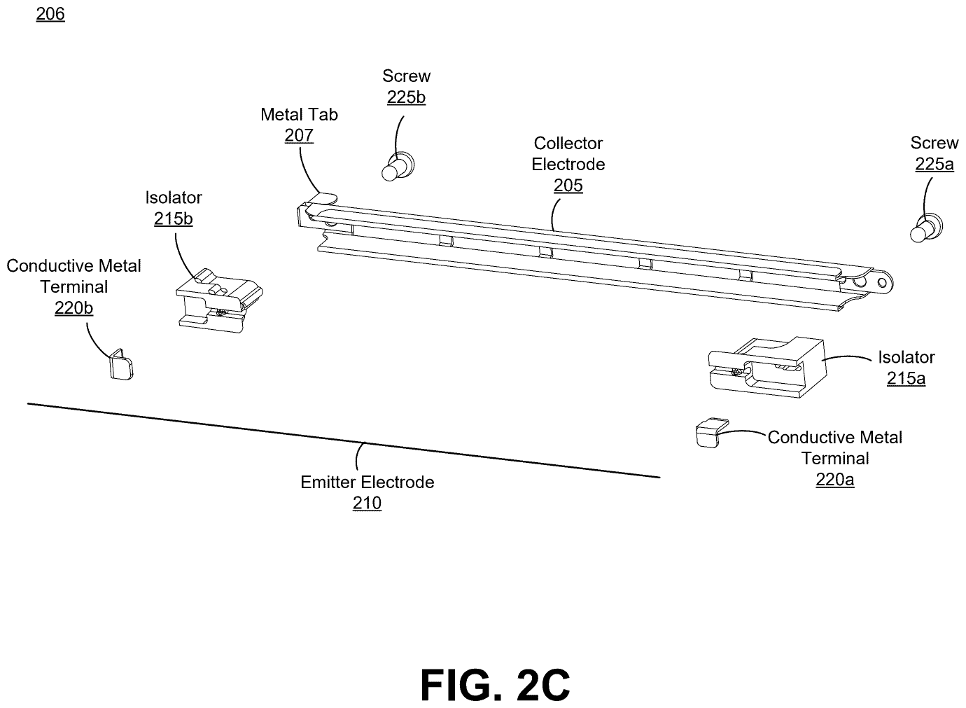

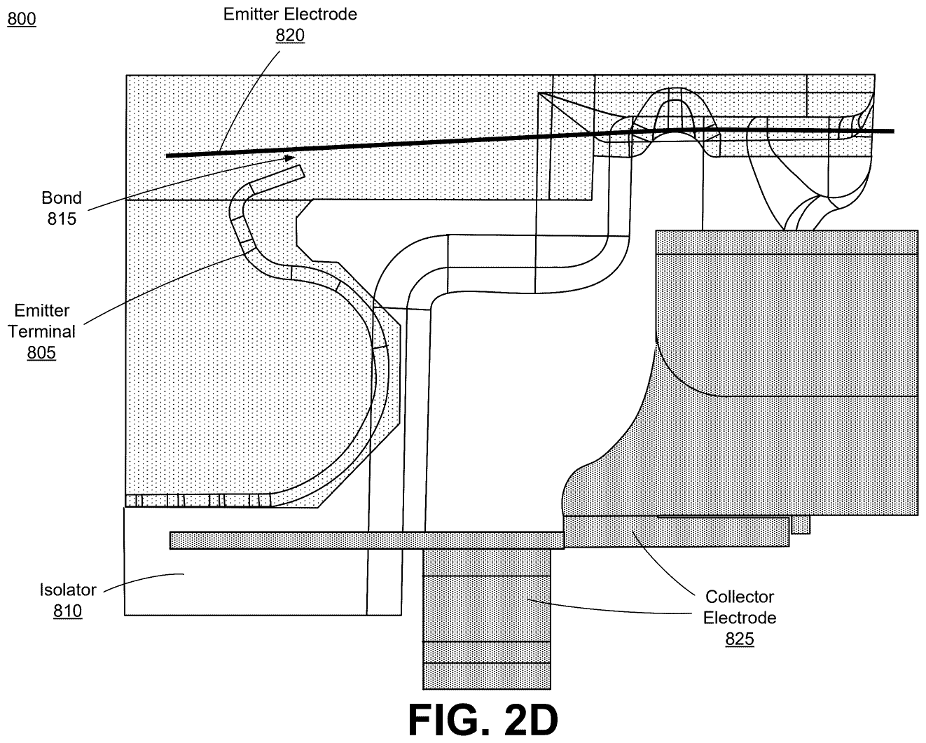

FIG. 2A illustrates a front view 202 of an electro-hydrodynamic (EHD) air mover device 200, in accordance with one or more embodiments. The EHD air mover device 200 may include a collector electrode 205, an emitter electrode 210, an isolator 215a, and an isolator 215b. The EHD air mover device 200 may include one or more additional components not shown in FIG. 2A. In general, the EHD air mover device 200 may include features for mounting and aligning electrodes to optimize performance, including spring-loaded conductive terminals and structural end caps with ribs and lips for secure placement. The EHD air mover device 200 may be an embodiment of the EHD fluid mover device 100.

The collector electrode 205 and the emitter electrode 210 may be attached to and held in a preferred position by the isolators 215a, 215b. The isolators 215a, 215b may be in the form of insulating end caps, located at longitudinal ends of the collector electrode 205 and the emitter electrode 210. The isolators 215a, 215b may be made of one or more non-conductive materials.

An air gap and spatial alignment between the collector electrode 205 and the emitter electrode 210 may be maintained by the isolators 215a, 215b. Precise positioning of the isolators 215a, 215b may ensure an adequate creep distance and air gap between the collector electrode 205 and the emitter electrode 210 in order to prevent electrical arcing within the EHD air mover device 200. In this manner, the corona discharge and resulting ionic flow of the EHD air mover device 200 can be more easily maintained at a desired power level without interruption by arcing that could result from the air gap distance between the collector electrode 205 and the emitter electrode 210 reduced below a threshold distance (e.g., creep distance) at any point in space or time.

FIG. 2B illustrates a bottom view 204 of the EHD air mover device 200, in accordance with one or more embodiments. The isolator 215a may include a slot for a conductive metal terminal 220a (e.g., positive high-voltage terminal, or HV+ terminal). As shown in FIG. 2A, the isolator 215b may also include a position adjacent or within the structure for contact to Metal Tab 207 (e.g., negative high-voltage terminal, or HV− terminal). Each slot for the corresponding conductive metal terminal 220a, 220b may have an access within the respective isolator 215a, 215b to allow access to at least two orthogonal surfaces of the corresponding conductive metal terminal 220a, 220b.

The conductive metal terminal 220a may be utilized to attach one end of the emitter electrode 210 (e.g., wire) via a solder connection, and the conductive metal terminal 220b may be utilized to attach the other end of the emitter electrode 210 via another solder connection. At least one end of the collector electrode 205 may include a metal tab 207 extending in a direction away from the emitter electrode 210. The metal tab 207 may be used as an electrical contact point for the collector electrode 205 to the power supply (e.g., the negative high-voltage, or HV−) and/or to the ground.

FIG. 2C illustrates a detailed view 206 of components of the EHD air mover device 200, in accordance with one or more embodiments. In addition to components shown in FIGS. 2A-2B, the EHD air mover device 200 may further include a pair of screws 225a, 225b. The screw 225a may be used to connect the collector electrode 205 to the isolator 215a, and the screw 225b may be used to connect the collector electrode 205 to the isolator 215b. The emitter electrode 210 may be implemented as an emitter wire. One longitudinal end of the emitter electrode 210 may be connected to the conductive metal terminal 220a (e.g., positive high-voltage terminal, or HV+ terminal), and the other longitudinal end of the emitter electrode 210 may be connected to the conductive metal terminal 220b (e.g., HV+ terminal that is for mechanical attachment only).

Each conductive metal terminal 220a, 220b may have a flat surface of a sufficient size. The flat surface of each conductive metal terminal 220a, 220b may be made of one or more conductive materials that facilitate firmly attaching a wire of the emitter electrode 210 to each conductive metal terminal 220a, 220b via a solder, weld, or other connection (not shown in FIG. 2C) to hold the wire of the emitter electrode 210 in place and under an appropriate tension when the EHD air mover device 200 is assembled. The tension may be sufficient to minimize or at least reduce sagging of the emitter electrode 210 and/or excess movement of the emitter electrode 210, which would alter the air gap distance from the collector electrode 205 to the emitter electrode 210 and potentially induce arcing within the EHD air mover device 200.

FIG. 2D illustrates Emitter Terminal 805, which is an alternative implementation of Conductive Metal Terminal 220b. While this provides mechanical and structural integrity of the placement of Emitter Electrode, it provides a flat surface that facilitates firmly attaching a wire of emitter electrode 210 without having to apply significant tension during the solder, weld, or other attachment process. Pressure may be applied to the surface of Emitter Terminal 805 until pressed against the surface of the isolator 810, and once the solder, weld, or other attachment step is complete, the pressure on emitter electrode may be released, and transfer that pressure to the wire, which will now have a tension applied to it as determined by the geometry and material selection of Emitter Terminal 805 in order to establish a resulting tension between 50 g and 400 g force.

### Isolation Housing for Electro-Hydrodynamic Air Mover Device

The normal operation of the EHD air mover device 200 requires creation of an electrical field between the emitter electrode 210 and the collector electrode 205, which can be achieved by applying a large differential voltage between the emitter electrode 210 and the collector electrode 205. A positive biased voltage may be generated by a power supply and applied to the emitter electrode 210, while the collector electrode 205 may remain neutral (i.e., grounded). Alternatively, a negative biased voltage generated by the power supply may be applied to the collector electrode 205. The electrical field established between the emitter electrode 210 and the collector electrode 205 may need to be maintained at a sufficiently large magnitude to create an electrical field gradient between electrodes of the EHD air mover device 200 that is strong enough to partially ionize fluid molecules (e.g., air) in a region of the emitter electrode 210 and create a plasma in the, i.e., the corona discharge. The ionized molecules created in the area of the corona discharge may be accelerated toward the collector electrode 205 via an electromagnetic force exerted by the electrical field to form an air flow (i.e., ionic wind).

When the EHD air mover device 200 is installed inside a chassis of another electronic device (e.g., tablet, laptop computer, high-end display device, etc.) for providing a cooling airflow, it is desirable to shield other electrical and conductive components within the electronic device from the electrical field and charged ions being created by the EHD air mover device 200 to avoid undesired short circuits and arcs, or damage to other components within the electronic device. It may further be beneficial to duct the desired ionic wind generated by the EHD air mover device 200 to maximize or at least increase the cooling effect, e.g., by directing such airflow where desired such as exhausting the airflow across a heat pipe or vapor chamber, which can result into a greater system cooling capacity than either the heat pipe or the EHD air mover device 200 alone could provide. Additionally, it may be desirable to allow for an assembly that includes the EHD air mover device 200 to be replaceable within the electronic device and exchanged without having to solder wires or connections that could damage either a connection between the emitter electrode 210 and isolators of the EHD air mover device 200, and/or a connection between the power supply of the EHD air mover device 200 and the emitter electrode 210.

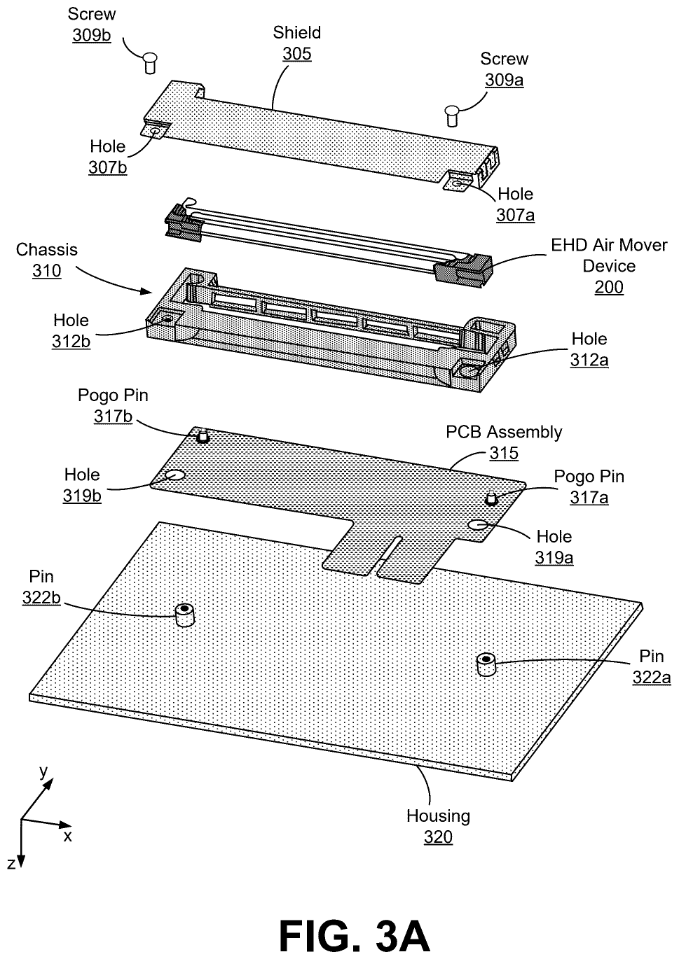

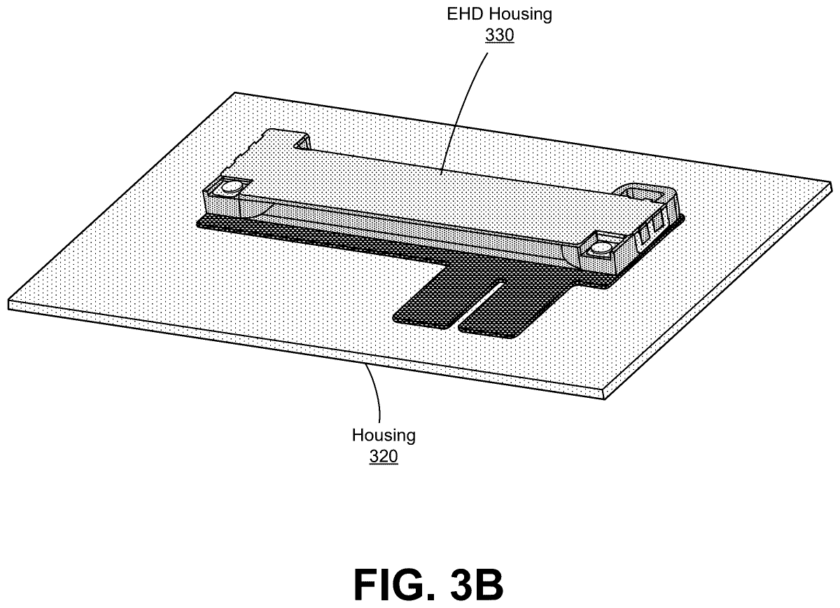

FIG. 3A illustrates components of an isolation housing for the EHD air mover device 200, in accordance with one or more embodiments. The isolation housing for the EHD air mover device 200 can be referred to herein as an “EHD housing”. In addition to the EHD air mover device 200, the EHD housing may further include a shield 305, a pair of screws 309a, 309b, a chassis 310, a printed circuit board (PCB) assembly 315, and a pair of pogo pins 317a, 317b. The EHD housing may be affixed, via a pair of pins 322a, 322b, to a bottom of a housing 320 of an electronic device into which the EHD air mover device 200 is integrated to provide an air flow for cooling components of the electronic device. The EHD housing may include one or more additional components not shown in FIG. 3A. FIG. 3B illustrates a top view of an EHD housing 330 placed on the bottom of the housing 320, in accordance with one or more embodiments. The EHD housing 330 shown in FIG. 3B may include the components illustrated in FIG. 3A, i.e., the shield 305, the pair of screws 309a, 309b, the EHD air mover device 200, the chassis 310, the PCB assembly 315, and the pair of pogo pins 317a, 317b.

The shield 305 may represent an upper surface of the EHD housing 330. The shield 305 may include a pair of holes 307a, 307b that can be used by the pair of screws 309a, 309b for affixing the shield 305 to the chassis 310. The shield 305 may further include an electrical non-conductive layer (e.g., Mylar or Kapton tape) to provide the required electrical isolation of the top of the EHD housing 330.

The chassis 310 may be a non-conductive chassis shaped to hold the EHD air mover device 200 in a desired position. The chassis 310 may form side walls and ducting of the EHD housing 330. The chassis 310 may include a pair of holes 312a, 312b aligned with the pair of holes 307a, 307b of the shield 305, so that the pair of screws 309a, 309b may pass down vertically (e.g., along the z dimension) through the pair of holes 307a, 307b and then the pair of holes 312a, 312b, effectively affixing the shield 305 to the chassis 310. A bottom surface of the chassis 310 may include a pair of holes (not shown in FIG. 3A) that can allow the pair of pogo pins 317a, 317b to enter the chassis 310 and make contact with electrical contact terminals (e.g., the conductive metal terminals 220a, Metal Tab 207) that are part of the EHD air mover device 200.

A bottom wall of the EHD housing 330 may made of the multi-layer PCB assembly 315. The PCB assembly 315 may provide an electrical isolation (i.e., shielding) required at the bottom of the EHD housing 330. The PCB assembly 315 may also include connections to the system electrical ground within the electronic device where the EHD housing 330 is being installed. The PCB assembly 315 may provide one or more conductive traces within one or more of its inner layers, i.e., a trace at one end connected electrically to the EHD power supply (e.g., via a solder connector or high-voltage connector), and on the other end connected to spring-actuated electrically conductive pogo pins 317a, 317b. The PCB assembly 315 may include a multi-layer PCB for carrying a high positive voltage signal (e.g., HV+ voltage signal), high negative voltage signal (e.g., HV− voltage signal), and ground signal, i.e., the PCB assembly 315 may represent a platform for components of a power supply. All or part of the power supply componentry may be built onto the PCB of the PCB assembly 315.

The PCB assembly 315 may accomplish multiple purposes. First, the PCB assembly 315 may function as a mechanical floor of the EHD housing 330. Second, since the PCB assembly 315 is made of one or more dielectric materials, the PCB assembly 315 may be a part of and/or bottom layer of the Faraday shielding containing the electrical field and electrical charge of the EHD air mover device 200. Third, one layer of the PCB assembly 315 may carry ground and/or HV− connections (i.e., signals) to the EHD air mover device 200. Fourth, the PCB assembly 315 may include a separate layer (hence electrically isolated and shielded layer) that can carry HV+ power signal to the EHD air mover device 200. Fifth, the PCB assembly 315 may host integrated components making up some or all of necessary EHD power supply components, Sixth, the PCB assembly 315 may contain traces of copper in the form of a linear coil placed directly under the location of the ICE placement that is capable of generating a magnetic field such that motion can be induced in a magnetically sensitive apparatus for the purpose of providing a cleaning action on surfaces of the ICE including the emitter electrode 210 or collector electrode 205

The pogo pins 317a, 317b may be soldered or otherwise affixed to the PCB assembly 315. The pogo pins 317a, 317b may represent spring-loaded pins configured for robust electrical connections. The EHD housing 330 may be assembled by utilizing the pair of screws 309a, 309b that pass down vertically (e.g., along the z dimension) through the series of aligned holes 307a, 307b in the shield 305, the pair of holes 312a, 312b in the chassis 310, and a pair of holes 319a, 319b in the PCB assembly 315. The pair of screws 309a, 309b may be ultimately attached to a bottom of the housing 320 of the electronic device in which the EHD housing 330 is installed, e.g., to the pair of pins 322a, 322b at the bottom of the housing 320. When the EHD air mover device 200 is placed within the chassis 310 and the shield 305 is secured down to complete the EHD housing 330, springs in the pogo pins 317a, 317b may be compressed ensuring an electrical contact is maintained between electrical contact terminals of the EHD air mover device 200 (e.g., the conductive metal terminals 220a, 207) and the pogo pins 317a, 317b.

To ensure that an upward force of the springs of the pogo pins 317a, 317b exerted on the EHD air mover device 200 does not cause an assembly of the EHD housing 330 to lift or deform, the shield 305 may be made of metal or some other material with sufficient thickness and strength to resist deforming. The shield 305 may be further held down by hooking over hold-down tabs formed on external sides of the chassis 310 (e.g., hold-down tabs 324a, 324b as shown in FIG. 3A for one external side of the chassis 310). A hollow cylinder of a non-conductive foam may be wrapped around the pogo pins 317a, 317b to create a tighter fit within the holes at the bottom surface of the chassis 310, and to help reduce the risk of a shortened electrical creep path along the surface of the chassis 310 to the nearest conductor, which could cause short circuits and/or arcs. This may enable replacement of the EHD air mover device 200 by simply unscrewing and removing the shield 305 and lifting the EHD air mover device 200 out from the chassis 310 for replacement, without the necessity to impact or touch solder or other wire electrical interconnects.

The EHD housing 330 shown in FIG. 3B may include top, bottom, and side walls. Each of the top, bottom, and side walls of the EHD housing 330 may include a layer to electrically isolate the EHD air mover device 200 and its generated electrical field and charged ions from components or an environment outside the EHD housing 330, e.g., environment of a housing of an electronic device into which the EHD housing 330 is integrated. An enclosing structure (e.g., Faraday cage) of the EHD housing 330 may minimize or at least reduce an electromagnetic interference and allows modular assembly for easy field replacement. In one or more embodiments, the shield 305, the EHD air mover device 200, and the chassis 310 remain assembled for replacement. To overcome fluid boundary-layer effects in the exhausting ionic wind of the EHD air mover device 200 that can cause very low flow velocity immediately adjacent to the walls of the EHD housing 330, the chassis 310 may feature an outlet duct shape that flares outward to the sides of the EHD housing 330.

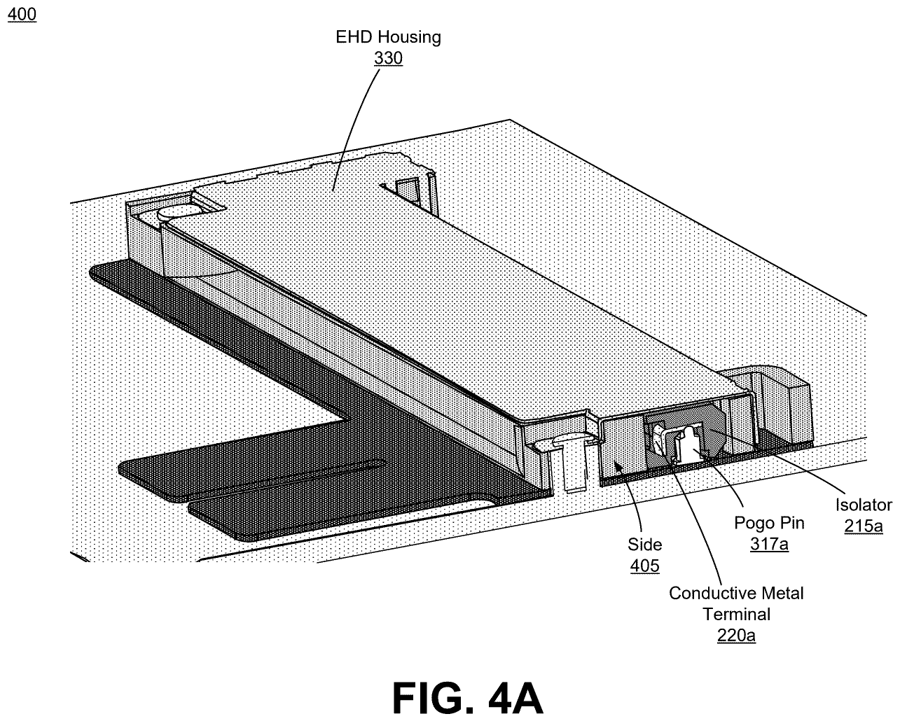

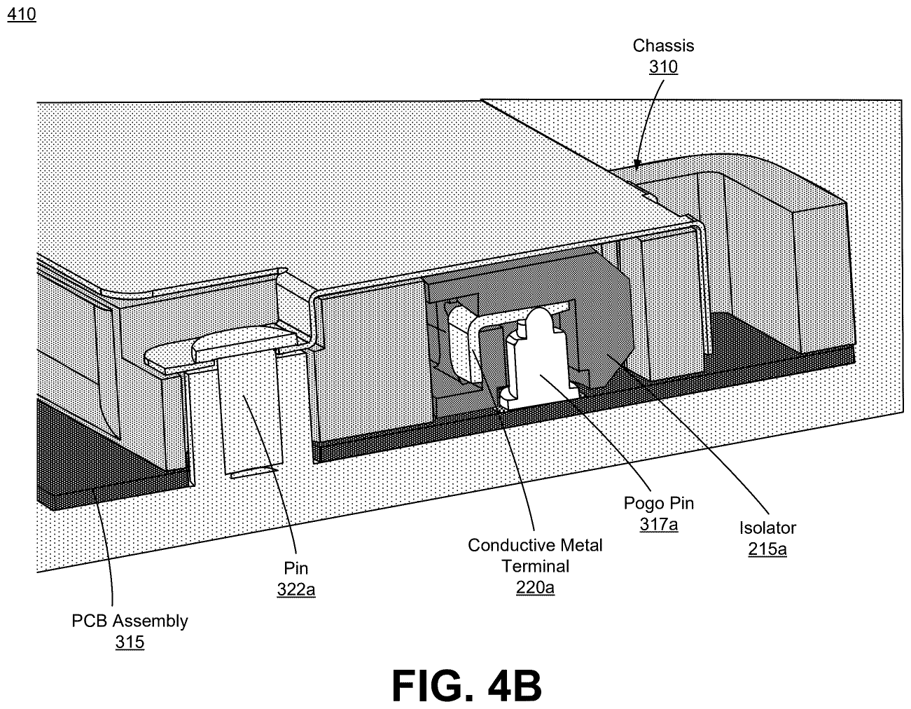

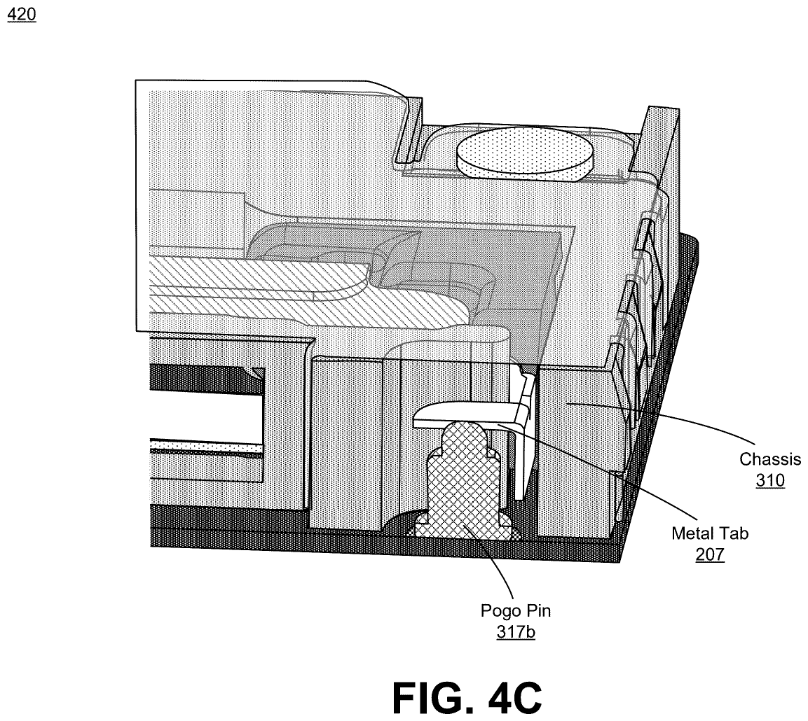

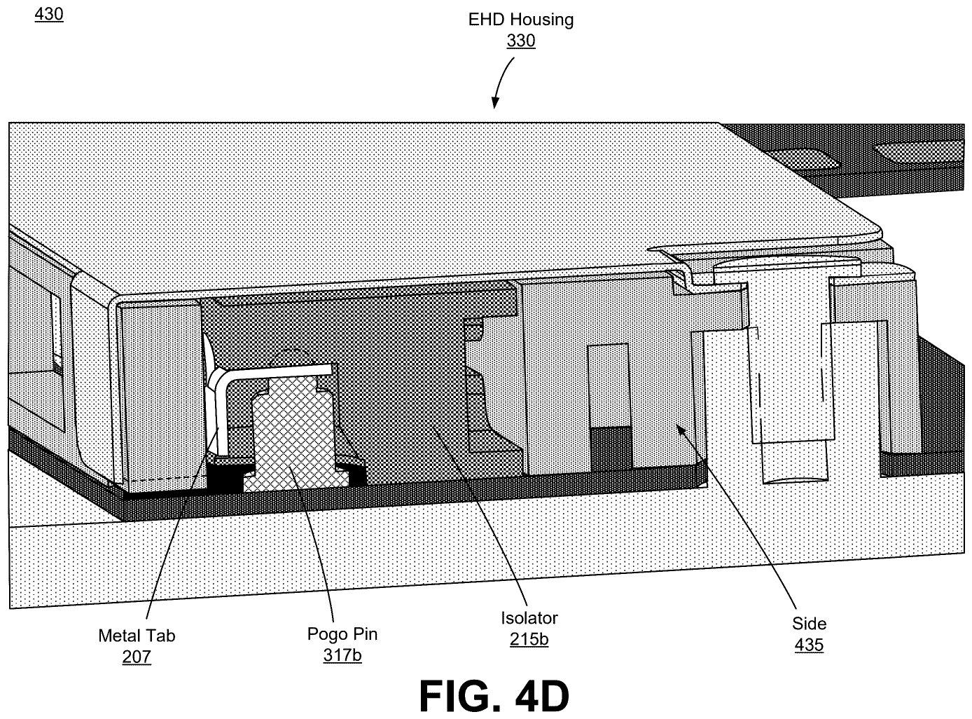

FIG. 4A illustrates a side angled view 400 of the EHD housing 330, in accordance with one or more embodiments. The side angled view 400 illustrates a cross-sectional view of a side 405 of the EHD housing 330. The side 405 is exposed in FIG. 4A such that to show the electrical contact between the conductive metal terminal 220a (e.g., positive high-voltage terminal, or HV+ terminal) of the EHD air mover device 200 and the pogo pin 317a. The conductive metal terminal 220a is placed within a slot of the isolator 215a, and the isolator 215a effectively surrounds the pogo pin 317a. FIG. 4B illustrates an enlarged side view 410 of the electrical contact between the conductive metal terminal 220a and the pogo pin 317a that affixes the chassis 310 to the PCB assembly 315, in accordance with one or more embodiments. The enlarged side view 410 further shows the pin 322a that affixes the PCB assembly 315 to the bottom of the housing 320.

FIG. 4C illustrates a cross-sectional side view 420 of the electrical contact between the metal tab 207 (e.g., the negative high-voltage terminal collector electrode terminal) of the EHD air mover device 200 and the pogo pin 317b, in accordance with one or more embodiments. As shown in FIG. 2B, the metal tab 207 may be part of the collector electrode 205. The contact between the metal tab 207 and the pogo pin 317b may effectively affix the chassis 310 to the PCB assembly 315. FIG. 4D illustrates a cross-sectional side angled view 430 of the EHD housing 330, in accordance with one or more embodiments. The cross-sectional side angled view 430 illustrates a cross-sectional view of a side 435 of the EHD housing 330. The side 435 is exposed in FIG. 4D such that to show the electrical contact between the metal tab 207 (e.g., the negative high-voltage terminal or collector electrode terminal) of the collector electrode 205 and the pogo pin 317b. The metal tab 207 may be placed within a slot of the isolator 215b, and the isolator 215b may effectively surround the pogo pin 317b.

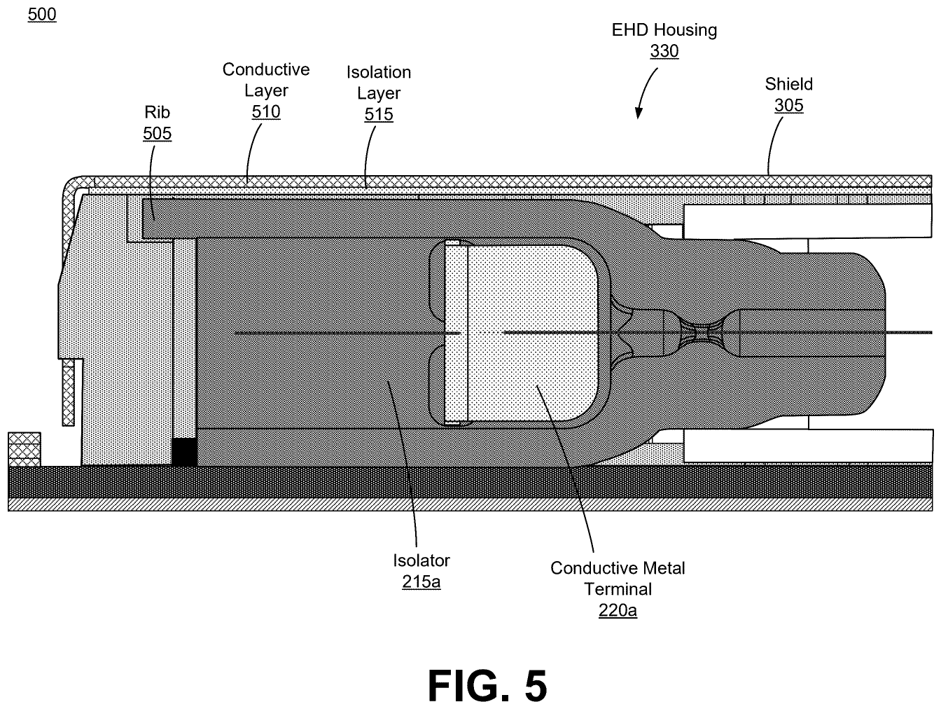

FIG. 5 illustrates a cross-sectional view 500 of the EHD housing 330, in accordance with one or more embodiments. The cross-sectional view 500 shows the conductive metal terminal 220a (e.g., the positive high-voltage terminal, or HV+ terminal) placed in a slot of the isolator 215a, i.e., the conductive metal terminal 220a is surrounded by the isolator 215a. The cross-sectional view 500 further shows a rib 505 added to the isolator 215a so that the EHD air mover device 200 is trapped within the EHD housing 330 while providing some extra space toward the shield 305. The cross-sectional view 500 also shows a pair of layers of the EHD housing 330, i.e., a conductive layer 510 and an isolation layer 515 placed below the conductive layer 510.

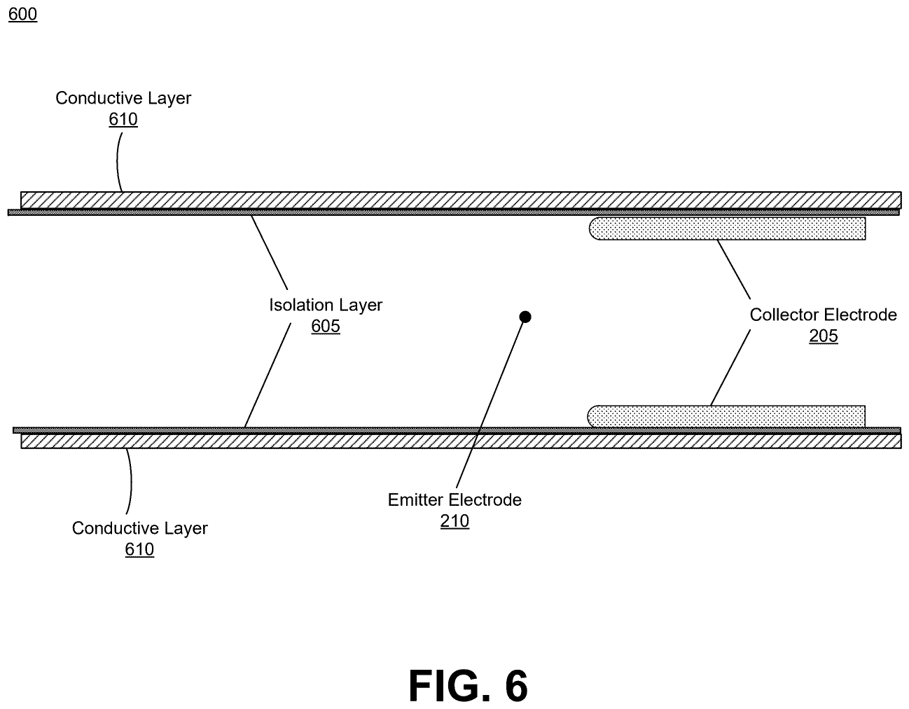

FIG. 6 illustrates a cross-sectional view 600 of an outside isolation for the EHD housing 330, in accordance with one or more embodiments. The outside isolation for the EHD housing 330 may include an isolation layer 605 and a conductive layer 610. The isolation layer 605 may be an embodiment of the isolation layer 515, and the conductive layer 610 may be an embodiment of the conductive layer 510. The isolation layer 605 and a conductive layer 610 may be of sufficient dimensions extending in front and back of the EHD housing 330 in order to establish a keep-out zone that contains all or at least most of the electrical field of the EHD air mover device 200 and to protect external components of a system where the EHD air mover device 200 is installed from being electrically charged or damaged by the operation of the EHD air mover device 200.

The isolation layer 605 may be made of one or more non-conductive materials (e.g., polyimide and/or mylar). A thickness of the isolation layer 605 may be approximately 2 mm (with or without an additional tolerance of typical films), which corresponds to a minimum electrical isolation of approximately 7 kV. The conductive layer 610 may be made of metal and may be grounded. A mechanical thickness of the conductive layer 610 should be practical for achieving objectives of a system into which the EHD housing 330 is integrated. One means of achieving both isolation and a grounded conductive layer on the mounting surface of the EHD housing is to incorporate these structures within the PCB Assembly 315 where the isolation layers of the PCB form the isolation layer 605 and the bottom metal layer forms Conductive Layer 610.

The isolation layer 605 and the conductive layer 610 may provide for keep out zones and isolation within the EHD housing 330. The keep out zones and isolation may be achieved an upstream of the emitter electrode 210 to avoid disruption of the electrical field generated by the operation of the EHD air mover device 200, and to protect the electronic system (e.g., laptop, tablet, etc.) where the EHD air mover device 200 is installed. For example, either no foreign objects may be allowed within approximately 8 mm upstream of the emitter electrode 210, or if allowed, these foreign objects must be grounded and isolated with more than 7 kV rating. The keep out zones and isolation may be also achieved in the outflow downstream of the EHD housing 330, and components may need to be isolated from the collector electrode 205 and grounded, e.g., for a distance of at least 2 mm. In one or more embodiments, all sides of the EHD housing 330 are electrically isolated by the isolation layer 605. In this manner, there is no longer a need to manage the keep-out zone extending up to, e.g., 7 mm to 10 mm in front of the emitter electrode 210, which eases an integration into the host system and reduces the risk of electrical faults at the host system. In one or more embodiments, a distance between the emitter electrode 210 and the collector electrode 205 is 1.8 mm±50 um set to prevent arcing between electrodes of the EHD air mover device 200. A relative location of the emitter electrode 210 may be approximately 8 mm from an inlet of the EHD air mover device 200.

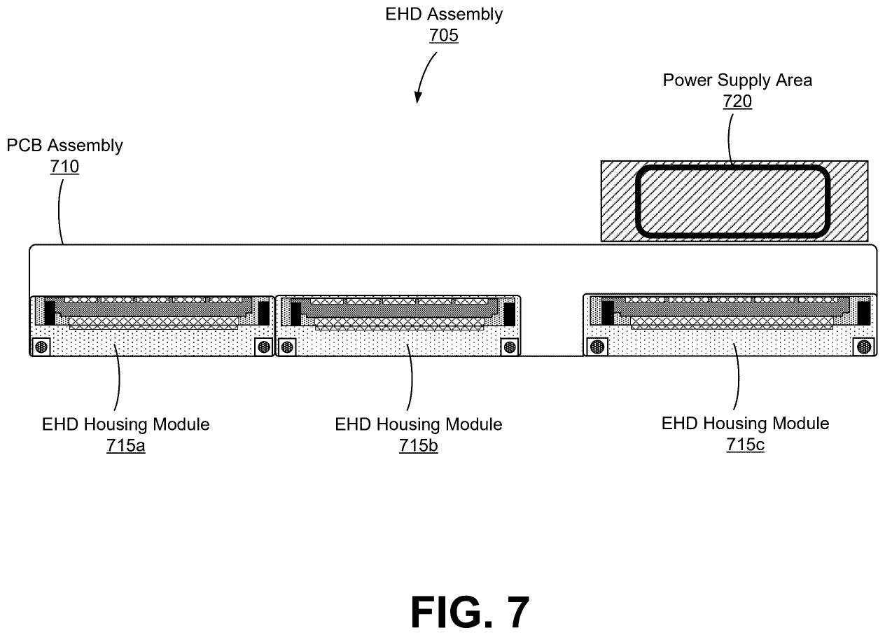

FIG. 7 illustrates a top view 700 of an EHD assembly 705, in accordance with one or more embodiments. The EHD assembly 705 may include an elongated PCB assembly 710 and EHD housing modules 715a, 715b, 715c placed on top of the elongated PCB assembly 710. The elongated PCB assembly 710 may be an embodiment of the PCB assembly 315, and each of the EHD housing modules 715a, 715b, 715c may be an embodiment of the EHD housing 330. In such configuration, some or all power supply componentry is integrated into the floor of housing assembly, i.e., into a power supply area 720 of the elongated PCB assembly 710. The elongated PCB assembly 710 may span across an entire width of back of an electronic device (e.g., laptop) having components that are being cooled. The elongated PCB assembly 710 may hold multiple EHD air mover devices 200, pogo pin connector sets, and top covers (e.g., shields), all leveraging the same PCB “bottom layer” and power supply.

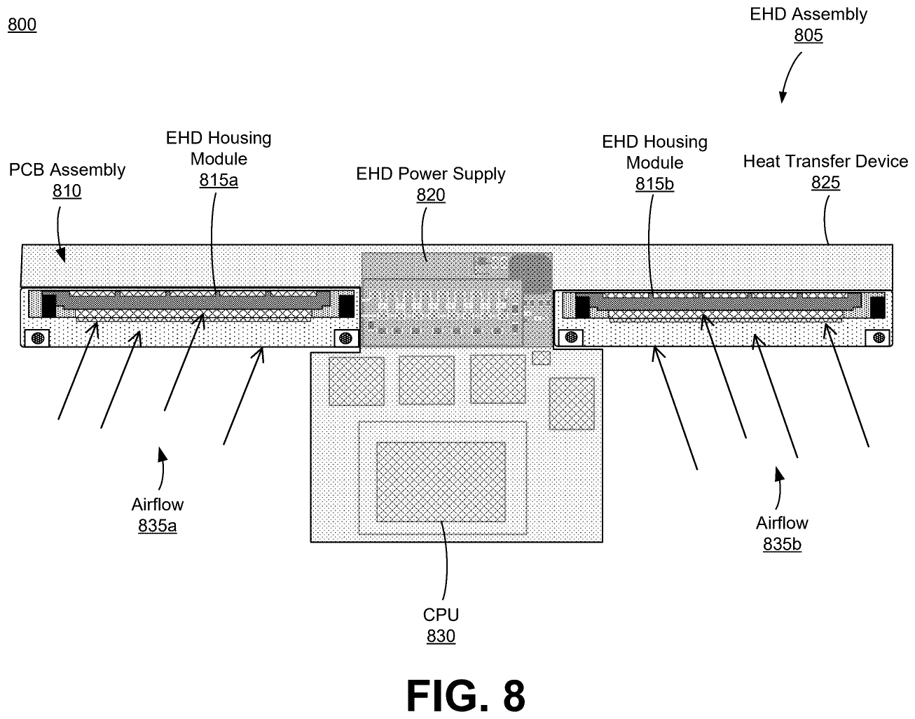

FIG. 8 illustrates a top view 800 of an EHD assembly 805, in accordance with one or more embodiments. The EHD assembly 805 may include a PCB assembly 810, EHD housing modules 815a, 815b, and an EHD power supply 820. The EHD housing modules 815a, 815b may be placed on top of the PCB assembly 810, and the EHD power supply 820 may be mounted on a bottom layer of the EHD assembly 805, i.e., on the PCB assembly 810. The PCB assembly 810 may be an embodiment of the PCB assembly 315, and each of the EHD housing modules 815a, 815b may be an embodiment of the EHD housing 330.

In one or more embodiments, a heat transfer device 825 is placed on top of the PCB assembly 810, the EHD power supply 820, and a central processing unit (CPU) 830 and one or more other components of an electronic system (e.g., laptop) into which the EHD assembly 805 is integrated. The heat transfer device 825 may be a heat pipe, heat spreader, thin vapor chamber, or some other device that facilitates heat transfer. The heat transfer device 825 may carry heat from one or more hot components of the electronic system (e.g., the CPU 830) to exhaust airflows 835a, 835b coming from EHD air mover devices placed within the EHD housing modules 815a, 815b. In this manner, more active exhausting away from the electronic system to outside ambient conditions can be achieved. As shown in FIG. 8, the heat transfer device 825 may be placed over the EHD power supply 820, to help carry some heat being generated by the operation of the EHD power supply 820, in effect to achieve self-cooling of the EHD power supply 820. The exhaust airflows 835a, 835b generated by the EHD air mover devices placed within the EHD housing modules 815a, 815b may move through fins on bottom/back of the heat transfer device 825 extending down into the airflow and are coated with, e.g., Ozone-destroying catalyst.

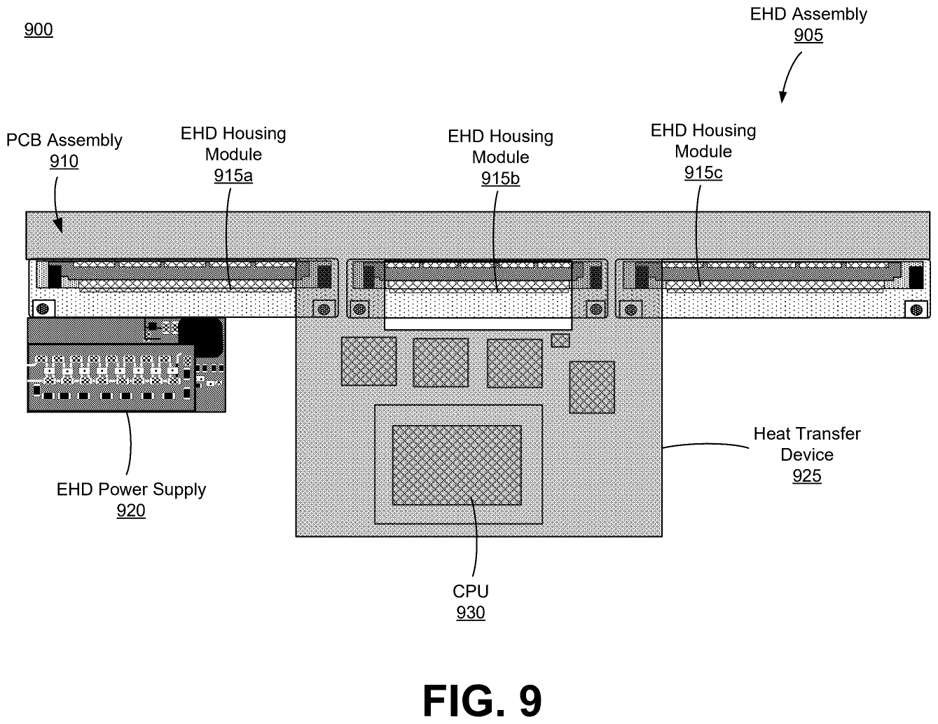

FIG. 9 illustrates a top view 900 of an EHD assembly 905, in accordance with one or more embodiments. The EHD assembly 905 may include a PCB assembly 910, EHD housing modules 915a, 915b, 915c, and an EHD power supply 920. The EHD housing modules 915a, 915b, 915c may be placed on top of the PCB assembly 910, and the EHD power supply 920 may be mounted adjacent to the EHD housing module 915a. The PCB assembly 910 may be an embodiment of the PCB assembly 315, and each of the EHD housing modules 915a, 915b, 915c may an embodiment of the EHD housing 330.

A heat transfer device 925 may be placed on top of the PCB assembly 910, and a CPU 930 (and, optionally, one or more additional components) of an electronic system (e.g., laptop) into which the EHD assembly 905 is integrated. The heat transfer device 925 may be a heat pipe, heat spreader, thin vapor chamber, or some other device that facilitates heat transfer. In comparison with the EHD assembly 805 of FIG. 8, the EHD assembly 905 includes an extra EHD housing module for achieving additional airflow, and the EHD power supply 920 is not placed under the heat transfer device 925.

Embodiments of the present disclosure are directed to an isolation housing (e.g., the EHD housing 330) for an EHD air mover device (e.g., the EHD air mover device). The isolation housing may include the EHD air mover device, a shield (e.g., the shield 305) placed on top of the EHD air mover device, a PCB assembly (e.g., the PCB assembly 315), and a chassis (e.g., the chassis 310). The shield may form an upper wall of the isolation housing. The PCB assembly may be made of one or more dielectric materials and may form a bottom wall of the isolation housing. The PCB assembly may include a PCB that carries signal connections for at least one of a positive bias voltage signal (e.g., HV+ voltage signal) for the EHD air mover device, a negative bias voltage signal (e.g., HV− voltage signal) for the EHD air mover device, or a ground signal for the EHD air mover device. The chassis may be made of one or more non-conductive materials and may form side walls of the isolation housing. The chassis may be shaped to hold the EHD air mover device in a defined position within the isolation housing. A first surface of the chassis may be affixed to the shield, and a second surface of the chassis opposite to the first surface may be affixed to the PCB assembly. The isolation housing may further include a power supply mounted on top of the PCB assembly. The power supply may generate at least one of the positive bias voltage signal or the negative bias voltage signal for the EHD air mover device.

The isolation housing may further include a pair or more of screws (e.g., the pair of screws 309a, 309b) that affixes the shield to the chassis. The pair or more of screws may propagate along a first dimension (e.g., the z dimension) through a pair of holes in the shield (e.g., the pair of holes 307a, 307b) and a pair of holes in the chassis (e.g., the pair of holes 312a, 312b) that are aligned to the pair of holes in the shield. The pair of screws may further propagate along the first dimension through a pair of holes in the PCB assembly (e.g., the pair of holes 319a, 319b) that are aligned to the pair of holes in the chassis. The pair of screws may be attached to a pair of pins (e.g., the pins 322a, 322b) at a bottom surface of a housing (e.g., the housing 320) of an electronic device in which the isolation housing is installed.

The isolation housing may further include a pair of spring-actuated electrically conductive pins (e.g., the pogo pins 317a, 317b) entering the chassis though a pair of holes at a bottom surface of the chassis. The pair of spring-actuated electrically conductive pins may be in electrical contact with the EHD air mover device. The pair of spring-actuated electrically conductive pins may be affixed to the PCB assembly.

The isolation housing may further include a power supply having components integrated into the PCB. The power supply may supply at least one of the positive bias voltage signal or the negative bias voltage signal to the EHD air mover device. A first layer of the PCB may carry at least one of the negative bias voltage signal and / or the ground signal to the EHD air mover device, and a second layer of the PCB may carry the positive bias voltage signal to the EHD air mover device.

The isolation housing may further include an isolation layer (e.g., the isolation layer 605) made of one or more non-conductive materials and a conductive layer (e.g., the conductive layer 610) made of one or more conductive materials. The isolation layer may be placed on top of the shield. The conductive layer may be placed on top of the isolation layer and may form an outside wall of the isolation housing. In one or more embodiments, an entire electrical field of the EHD air mover device is contained within the isolation housing.

Embodiments of the present disclosure are further directed to a housing assembly (e.g., the EHD assembly 705, the EHD assembly 805, or the EHD assembly 905) that includes multiple isolation housings for multiple EHD air mover devices (e.g., the EHD housing modules 715a, 715b, 715c, the EHD housing modules 815a, 815b, or the EHD housing modules 915a, 915b, 915c). Each isolation housing in the housing assembly may include a respective EHD air mover device, a shield (e.g., the shield 305) placed on top of the respective EHD air mover device, and a chassis (e.g., the chassis 310) made of one or more non-conductive materials that is affixed to the shield and shaped to hold the respective EHD air mover device in a defined position. The housing assembly may further include a PCB assembly (e.g., the PCB assembly 710, the PCB assembly 810, or the PCB assembly 910) made of one or more dielectric materials that forms a bottom wall of the housing assembly. The chassis of each isolation housing is affixed to the PCB assembly. The PCB assembly may include a PCB that carries signal connections for at least one of a positive bias voltage signal (e.g., HV+ voltage signal) for each EHD air mover device, a negative bias voltage signal (e.g., HV− voltage signal) for each EHD air mover devices, or a ground signal for each EHD air mover device.

The housing assembly may further include pairs of spring-actuated electrically conductive pins (e.g., multiple pairs of pogo pins 317a, 317b) affixed to the PCB assembly. Each pair of spring-actuated electrically conductive pins may affix the chassis of the respective EHD air mover device to the PCB assembly and may be in electrical contact with the respective EHD air mover device.

The PCB assembly of the housing assembly may include multiple components of a power supply (e.g., the EHD power supply 820 or the EHD power supply 920) that generates the positive bias voltage signal and the negative bias voltage signal. The components of the power supply may be placed between a first isolation housing (e.g., the EHD housing module 815a) and a second isolation housing (e.g., the EHD housing module 815b).

The housing assembly may further include a heat transfer device (e.g., the heat transfer device 825 or the heat transfer device 925) placed over the PCB assembly. The heat transfer device may carry heat away from one or more components of an electronic system into which the housing assembly is integrated and to an exhaust of the respective EHD air mover device. The power supply may be mounted on top of the PCB assembly and may generate at least one of the positive bias voltage signal or the negative bias voltage signal. The heat transfer device may be further placed over the power supply (e.g., the EHD power supply 820) for carrying heat generated by the power supply.

### Process Flow

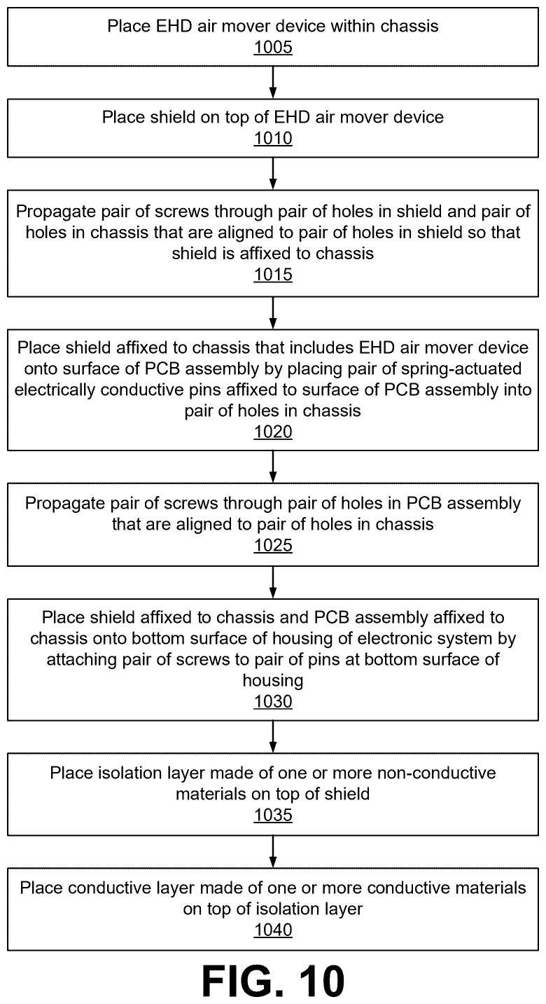

FIG. 10 is a flowchart for a method of assembling an EHD housing (e.g., the EHD housing 330), in accordance with one or more embodiments. Alternative embodiments may include more, fewer, or different steps from those illustrated in FIG. 10, and the steps may be performed in a different order from that illustrated in FIG. 10. These steps may be performed automatically by an assembly system without any human intervention.

The assembly system places 1005 an EHD air mover device (e.g., the EHD air mover device 200) within a chassis of the EHD housing (e.g., the chassis 310).

The assembly system places 1010 a shield of the EHD housing (e.g., the shield 305) on top of the EHD air mover device.

The assembly system propagates 1015 a pair of screws of the EHD housing (e.g., the pair of screws 309a, 309b) along a first dimension (e.g., the z dimension) through a pair of holes in the shield (e.g., the pair of holes 307a, 307b) and a pair of holes in the chassis (e.g., the pair of holes 312a, 312b) that are aligned to the pair of holes in the shield so that the shield is affixed to the chassis.

The assembly system places 1020 the shield affixed to the chassis that includes the EHD air mover device 200 onto a surface of a PCB assembly (e.g., the PCB assembly 315) by placing a pair of spring-actuated electrically conductive pins (e.g., the pogo pins 317a, 317b) that are affixed to the surface of the PCB assembly into a pair of holes at a bottom surface of the chassis.

The assembly system propagates 1025 the pair of screws along the first dimension through a pair of holes in the PCB assembly (e.g., the pair of holes 319a, 319b) that are aligned to the pair of holes in the chassis.

The assembly system places 1030 the shield affixed to the chassis and the PCB assembly affixed to the chassis onto a bottom surface of a housing of an electronic system (e.g., the housing 320) by attaching the pair of screws to a pair of pins (e.g., the pair of pins 322a, 322b) at the bottom surface of the housing.

The assembly system places 1035 an isolation layer (e.g., the isolation layer 605) made of one or more non-conductive materials on top of the shield.

The assembly system places 1040 a conductive layer made of one or more conductive materials on top of the isolation layer such that the conductive layer forms an outside wall of the EHD housing.

### ADDITIONAL CONSIDERATIONS

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. An isolation housing, comprising:
an electro-hydrodynamic (EHD) air mover device;
a shield placed on top of the EHD air mover device, the shield forming an upper wall of the isolation housing;
a printed circuit board (PCB) assembly made of one or more dielectric materials and forming a bottom wall of the isolation housing, the PCB assembly including a PCB that carries signal connections for at least one of a positive bias voltage signal for the EHD air mover device, a negative bias voltage signal for the EHD air mover device, or a ground signal for the EHD air mover device; and
a chassis made of one or more non-conductive materials and forming side walls of the isolation housing, the chassis shaped to hold the EHD air mover device in a defined position within the isolation housing, a first surface of the chassis affixed to the shield, and a second surface of the chassis opposite to the first surface affixed to the PCB assembly.

2. The isolation housing of claim 1, further comprising:
a pair of screws that affix the shield to the chassis, the pair of screws propagating along a first dimension through a pair of holes in the shield and a pair of holes in the chassis that are aligned to the pair of holes in the shield.

3. The isolation housing of claim 2, wherein the pair of screws further propagate along the first dimension through a pair of holes in the PCB assembly that are aligned to the pair of holes in the chassis.

4. The isolation housing of claim 3, wherein the pair of screws are attached to a pair of pins at a bottom surface of a housing of an electronic device in which the isolation housing is installed.

5. The isolation housing of claim 1, further comprising:
a pair of spring-actuated electrically conductive pins entering the chassis though a pair of holes in the chassis, the pair of spring-actuated electrically conductive pins in electrical contact with the EHD air mover device.

6. The isolation housing of claim 5, wherein the pair of spring-actuated electrically conductive pins are affixed to the PCB assembly.

7. The isolation housing of claim 1, further comprising:
a power supply having components integrated into the PCB, the power supply supplying at least one of the positive bias voltage signal or the negative bias voltage signal to the EHD air mover device.

8. The isolation housing of claim 1, wherein a first layer of the PCB carries at least one of the negative bias voltage signals or the ground signal to the EHD air mover device, and a second layer of the PCB carries the positive bias voltage signal to the EHD air mover device.

9. The isolation housing of claim 1, further comprising:
an isolation layer made of one or more non-conductive materials, the isolation layer placed on top of the shield; and
a conductive layer made of one or more conductive materials, the conductive layer placed on top of the isolation layer, the conductive layer forming an outside wall of the isolation housing.

10. The isolation housing of claim 1, wherein an entire electrical field of the EHD air mover device is contained within the isolation housing.

11. A housing assembly, comprising:
a plurality of isolation housings for a plurality of electro-hydrodynamic (EHD) air mover devices, each isolation housing of the plurality of isolation housings including:
a respective EHD air mover device of the plurality of EHD air mover devices,
a shield placed on top of the respective EHD air mover device, and
a chassis made of one or more non-conductive materials and affixed to the shield, the chassis shaped to hold the respective EHD air mover device in a defined position; and
a printed circuit board (PCB) assembly made of one or more dielectric materials and forming a bottom wall of the housing assembly, the chassis of each isolation housing affixed to the PCB assembly, the PCB assembly including a PCB that carries signal connections for at least one of a positive bias voltage signal of each for the plurality of EHD air mover devices, a negative bias voltage signal for each of the plurality of EHD air mover devices, or a ground signal for each of the plurality of EHD air mover devices.

12. The housing assembly of claim 11, further comprising:
a plurality of pairs of spring-actuated electrically conductive pins affixed to the PCB assembly, each of the plurality of pairs of spring-actuated electrically conductive pins affixing the chassis of the respective EHD air mover device to the PCB assembly, each of the plurality of pairs of spring-actuated electrically conductive pins in electrical contact with the respective EHD air mover device.

13. The housing assembly of claim 11, wherein the PCB assembly includes a plurality of components of a power supply that generates the positive bias voltage signal and the negative bias voltage signal.

14. The housing assembly of claim 13, wherein the PCB assembly includes metal traces that function as a coil to induce motion of a magnetically sensitive apparatus built into the EHD housing in order to provide lateral motion capable of cleaning structures within the EHD housing including Emitter Electrode and Collector Electrode, and such coil traces are driven by the plurality of components of the power supply.

15. The housing assembly of claim 13, wherein the plurality of components of the power supply are placed between a first isolation housing of the plurality of isolation housings and a second isolation housing of the plurality of isolation housings.

16. The housing assembly of claim 11, further comprising:
a heat transfer device placed over the PCB assembly, the heat transfer device carrying heat away from one or more components of an electronic system into which the housing assembly is integrated and to an exhaust of the respective EHD air mover device.

17. The housing assembly of claim 16, further comprising:
a power supply mounted on top of the PCB assembly, the power supply generating at least one of the positive bias voltage signal or the negative bias voltage signal,
wherein the heat transfer device is further placed over the power supply for carrying heat generated by the power supply.

18. An isolation housing, comprising:
an electro-hydrodynamic (EHD) air mover device;
a shield placed on top of the EHD air mover device, the shield forming an upper wall of the isolation housing;
a printed circuit board (PCB) assembly made of one or more dielectric materials and forming a bottom wall of the isolation housing, the PCB assembly carrying signal connections for a positive bias voltage signal for the EHD air mover device, and at least one of a negative bias voltage signal for the EHD air mover device or a ground signal for the EHD air mover device;
a chassis made of one or more non-conductive materials and forming side walls of the isolation housing, the chassis shaped to hold the EHD air mover device in a defined position within the isolation housing, a first surface of the chassis affixed to the shield, and a second surface of the chassis opposite to the first surface affixed to the PCB assembly; and
a power supply mounted on top of the PCB assembly, the power supply generating at least one of the positive bias voltage signal or the negative bias voltage signal.

19. The isolation housing of claim 18, further comprising:
a pair of screws that affix the shield to the chassis, the pair of screws propagating along a first dimension through a pair of holes in the shield, a pair of holes in the chassis that are aligned to the pair of holes in the shield, and a pair of holes in the PCB assembly that are aligned to the pair of holes in the chassis,
wherein the pair of screws are attached to a pair of pins at a bottom surface of a housing of an electronic device in which the isolation housing is installed.

20. The isolation housing of claim 18, further comprising:
a pair of spring-actuated electrically conductive pins affixed to the PCB assembly, the pair of spring-actuated electrically conductive pins entering the chassis though a second pair of holes of the chassis, the pair of spring-actuated electrically conductive pins in electrical contact with the EHD air mover device.

21. The isolation housing of claim 18, further comprising:
an isolation layer made of one or more non-conductive materials, the isolation layer placed on top of the shield; and
a conductive layer made of one or more conductive materials, the conductive layer placed on top of the isolation layer, the conductive layer forming an outside wall of the isolation housing.

22. The isolation housing of claim 18, further comprising:
dimensions at both an inlet side and an outlet side of the EHD air mover device, the dimensions being configured such that all high-voltage isolation is contained within the isolation housing of the EHD air mover device, thereby eliminating any requirement for an external keep-out zone adjacent the EHD air mover device.
